(19) United States
(12) Patent Application Publication
(10) Pub. No.: US 2018/0332642 A1
(43) Pub. Date: Nov. 15, 2018

(54) COUPLING A PLURALITY OF USER ENTITIES IN A COMMUNICATION NETWORK

(71) Applicant: SIEMENS AKTIENGESELLSCHAFT, München (DE)

(72) Inventors: Matthias SCHEFFEL, Unterhaching (DE); Joachim WALEWSKI, Unterhaching (DE); Florian ZEIGER, Höhenkirchen-Siegertsbrunn (DE)

(21) Appl. No.: 15/543,715

(22) PCT Filed: Jan. 15, 2015
(86) PCT No.: PCT/EP2015/050675

§ 371 Date: Jul. 14, 2017

(51) Int. Cl. H04W 76/14; H04W 8/08

(52) U.S. Cl. CPC H04W 76/14; H04W 8/082

(57) ABSTRACT

Systems and Methods are provided for coupling a plurality of user entities in a communication network. A device includes a first unit for providing communication links between each of the user entities and a core mobile network of the communication network, and a second unit for providing a number of virtual networks. Each of the provided virtual networks is configured to connect at least two of the user entities such that a direct communication between the connected at least two user entities is provided.

### CROSS REFERENCE TO RELATED APPLICATION

The present patent document is a § 371 nationalization of PCT Application Ser. No. PCT/EP2015/050675, filed Jan. 15, 2015, designating the United States, which is hereby incorporated by reference.

### FIELD

Embodiments relate to a device for coupling a plurality of user entities in a communication network, a method, and a computer program product for coupling a plurality of user entities in a communication network.

### BACKGROUND

Automation applications require, for example, a certain quality of service (QoS). When automation is realized via 4G cellular networks, data communication between automation devices, for example, between cranes and remote controls for the cranes, is required. Conventional deployments foresee that the data communication between the automation devices traverses the core mobile network of the 4G operators. By traversing the core mobile network, additional latencies and jitter may be induced. Also, more nodes are transited that increase the exposure to attacks. Therefore, the reliability and availability of the overall communication system may decrease that may bar the use of conventional 4G networks from QoS-demanding automation applications.

In current LTE deployments, direct communication between user equipment (UEs) is not provided. The LTE standard w allow for local IP access (LIPA), that provides local-area-network (LAN) access of UEs via a base station (eNodeB) and through a local gateway. Such a setup supports QoS-demanding applications, e.g. automation and remote control, as all communication may be handled locally without traversing the 4G operator's network. However, in many cases, the LAN is not present, and the solution proposed by the 3GPP standard does not work. Thus, LTE is used for best effort communication applications and not for QoS demanding automation applications.

### BRIEF SUMMARY

The scope of the present invention is defined solely by the appended claims and is not affected to any degree by the statements within this summary. The present embodiments may obviate one or more of the drawbacks or limitations in the related art.

An embodiment provides a device for coupling a plurality of user entities in a communication network. The device includes a first unit for providing communication links between each of the user entities and a core mobile network of the communication network, and a second unit for providing a number of virtual networks. Each of the provided virtual networks is configured to connect at least two of the user entities such that a direct communication between the connected at least two user entities is provided.

An embodiment provides a shortcut for direct communication between user entities, without traversing the core mobile network. The direct user entity communication is kept inside the device. The provided virtual network may be a virtual LAN. The device may incorporate a base station and a local gateway. For example, the base station may integrate the first unit, and the local gateway may integrate the second unit.

An embodiment provides a dedicated LAN that exists virtually within the local gateway. The local gateway is extended to host at least one instance of such a virtual LAN. For the example of LTE, existing eNodeBs may use the same local gateway interface as defined for LIPA for providing user entities or user equipment, e.g. automation devices, access to the virtual LAN. Direct communication between the user equipment is provided within the virtual LAN. The device provides QoS-demanding automation communication. Only signaling and billing data may traverse the core mobile network or 4G operator's network, and all data communication between the user equipment remains within that virtual LAN.

Embodiments reduce the attack surface, increases the security, and allow for comprehensive security measures. In addition, the performance may be increased, as data communication between the user equipment is kept inside the virtual LAN. Data traffic does not traverse the core mobile network and therefore jitter and latency from the core network is not affecting the data communication allowing for more QoS stringent applications in an industrial domain. Also, communication costs may be reduced by keeping data locally within the virtual LAN. Keeping direct user equipment communication inside the virtual LAN provided by the device also reduces the risk of suffering from link and node failures and congestion in the core mobile network.

For example, the user entity may be a user equipment (UE). Examples for UEs are automation devices, like cranes and remote controls for the cranes. The UE may be a device with an LTE transceiver and an interface with the LTE transceiver.

According to an embodiment, the core mobile network is a cellular network. In particular, the cellular network is a 4G network, for example an LTE network, a UMTS network, or a 5G network.

According to an embodiment, the communication network includes the core mobile network and at least one wireless mobile network. Moreover, the communication network may include an Internet Service Provider network.

According to an embodiment, the device includes a base station, where the base station integrates the first unit.

According to an embodiment, the base station is a NodeB.

According to an embodiment, the base station is an eNodeB.

According to an embodiment, the device includes a local gateway, where the local gateway integrates the second unit.

According to an embodiment, the device includes a processing unit having processing power and storing capacity, where the processing unit integrates the second unit.

According to an embodiment, the direct communication is a direct data communication between the at least two user entities connected by one of the provided virtual networks.

Direct data communication refers to data communication that does not traverse the core mobile network.

According to an embodiment, the device is configured to communicate signaling data and billing data with the core mobile network directly.

According to an embodiment, the device includes a virtualization unit for providing virtualized network functions to the plurality of user entities.

According to an embodiment, the device may be configured to run multiple instances of virtual LANs within the same local gateway of the device, facilitating multiple tenants, where each tenant has access to an own virtual LAN. Communication between virtual LANs of different tenants may be prohibited. The multiple virtual LANs within a local gateway may support the separation of different services with distinct industrial QoS requirements.

According to an embodiment, the virtualization unit is configured to provide a number of firewalls, where each of the provided firewalls is configured to couple at least two of the provided virtual networks.

The virtualization unit is configured to provide direct communication between user entities allocated to at least two different virtual networks that are coupled by the respective firewall.

According to an embodiment, the device includes an allocation unit, that is configured to allocate a certain user entity of the plurality of user entities to one certain virtual network of the provided virtual networks.

According to an embodiment, the device includes an allocation unit that is configured to allocate a certain user entity of the plurality of user entities to one certain virtual network of the provided virtual networks based on information that is indicative for a certain group the certain user entity is a part of.

According to an embodiment, the device includes a server for providing services to the plurality of user entities. The server may be a virtual server.

The respective unit or entity, e.g. the first unit or the second unit, may be implemented in hardware and/or in software. If the unit is implemented in hardware, the unit may be embodied as a device, e.g. as a computer or as a processor or as a part of a system, e.g. a computer system. If the unit is implemented in software, the unit may be embodied as a computer program product, as a function, as a routine, as a program code or as an executable object.

According to another embodiment, a method for coupling a plurality of user entities in a communication network is provided. The method includes providing communication links between each of the user entities and a core mobile network of the communication network, and providing a number of virtual networks, where each of the provided virtual networks is configured to connect at least two of the user entities such that a direct communication between the connected at least two user entities is provided.

According to another embodiment, a computer program product is provided including a program code for executing the above described method for coupling a plurality of user entities in a communication network when run on at least one computer.

A computer program product, such as a computer-program code, may be embodied as a memory card, USB stick, CD-ROM, DVD or as a file that may be downloaded from a server in a network. For example, the file may be provided by transferring the file including the computer program product from a wireless communication network.

### BRIEF DESCRIPTION OF THE DRAWINGS

FIG. 1 depicts a schematic block diagram of an embodiment of a device for coupling a plurality of user entities in a communication network.

FIG. 2 depicts a schematic block diagram of an embodiment of a device for coupling a plurality of user entities in a communication network.

FIG. 3 depicts a schematic block diagram of an embodiment of a device for coupling a plurality of user entities in a communication network.

FIG. 4 depicts a schematic block diagram of an embodiment of a device for coupling a plurality of user entities in a communication network.

FIG. 5 depicts a schematic block diagram of an embodiment of a device for coupling a plurality of user entities in a communication network.

FIG. 6 depicts a schematic block diagram of an embodiment of a device for coupling a plurality of user entities in a communication network.

FIG. 7 depicts an embodiment of a sequence of acts for coupling a plurality of user entities in a communication network.

### DETAILED DESCRIPTION

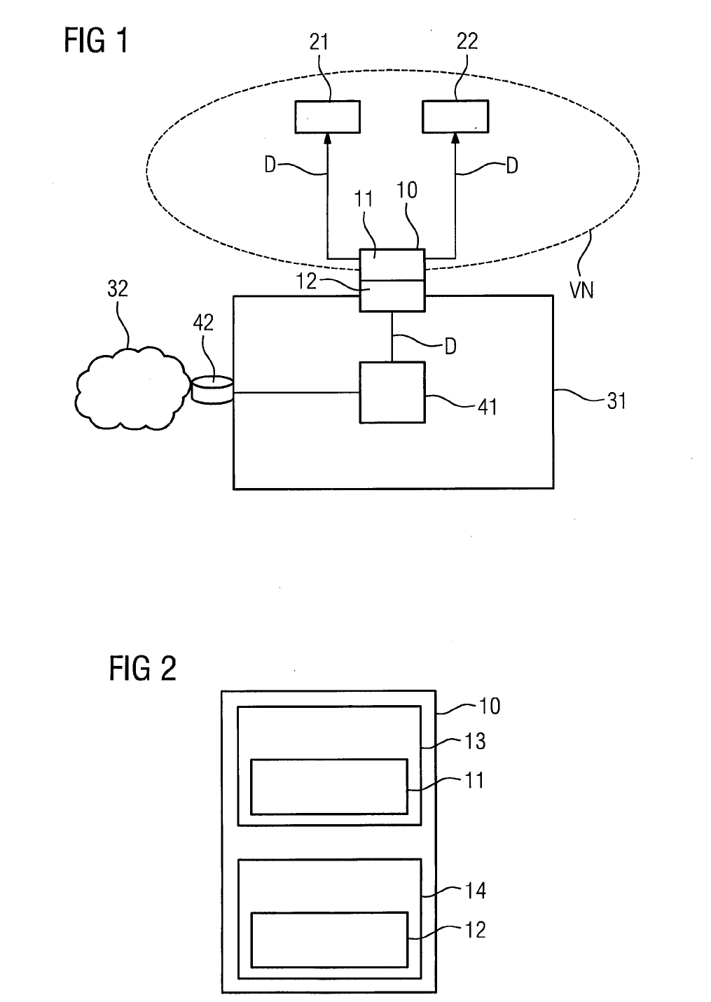

FIG. 1 depicts a schematic block diagram of an embodiment of a device 10 for coupling a plurality of user entities 21, 22 in a communication network 31, 32.

FIG. 1 depicts two user entities 21 and 22, but more may be provided. The communication network 31, 32 includes a core mobile network 31 and at least one wireless mobile network. The communication network 31, 32 may include an Internet-Service-Provider network 32.

The device 10 in FIG. 1 includes a first unit 11 and a second unit 12. The first unit 11 is configured to provide communication links between each of the user entities 21, 22 and the core mobile network 31 of the communication network 31, 32.

The second unit 12 is configured to provide a number of virtual networks VN. FIG. 1 depicts one virtual network VN, but more virtual networks may be provided. The virtual network VN is configured to connect the user entities 21, 22 such that a direct communication D between the connected user entities 21, 22 is established. For example, the direct communication between the two user entities 21, 22 is a direct data communication D. Direct data communication D occurs between the following entities: user entity 21, device 10, and user entity 22. The direct data communication D does not traverse the core mobile network 31 as such.

The core mobile network 31 of FIG. 1 may be a 4G network. Alternatively, the core mobile network 31 may be a UMTS network or a 5G network.

Further, FIG. 1 depicts a serving gateway 41 in the core mobile network 31 arranged between the device 10 and a further gateway 42 coupling the core mobile network 31 with the Internet-Service-Provider network 32. The gateway 42 may be a Packet-Data-Network gateway (PDN gateway).

In FIG. 2, a schematic block diagram of a second embodiment of a device 10 for coupling a plurality of user entities 21, 22 in a communication network 31, 32 is depicted. The device 10 of FIG. 2 may be arranged in a system, as shown in FIG. 1.

The device 10 of FIG. 2 includes a base station 13 and a local gateway 14. The base station 13 integrates the first unit 11. The local gateway 14 integrates the second unit 12. For the example that the core mobile network 31 is an LTE network, the base station 13 is an eNodeB. For the example that the core mobile network 31 is a UMTS network, the base station 13 is a NodeB.

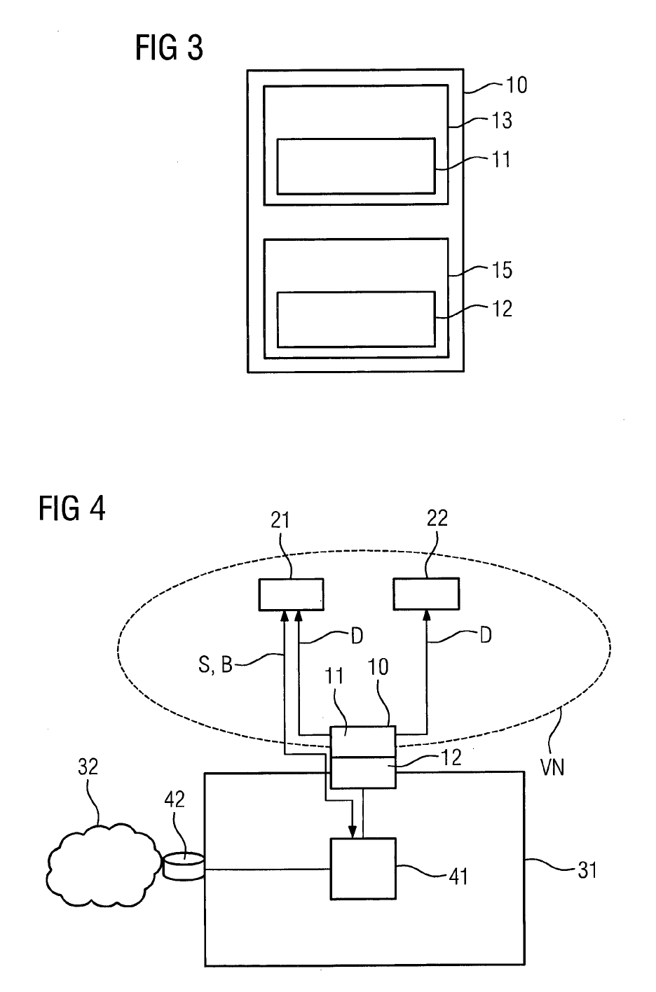

FIG. 3 depicts a schematic block diagram of an embodiment of a device 10 for coupling a plurality of user entities 21, 22 in a communication network. The embodiment of FIG. 3 differs from the embodiment of FIG. 2 in that the embodiment of FIG. 3 does not include a local gateway 14, but a processing unit 15 having processing power and storing capacity. The processing unit 15 of FIG. 3 integrates the second unit 12.

In FIG. 4, a schematic block diagram of an embodiment of a device 10 for coupling a plurality of user entities 21, 22 in a communication network 31, 32 is depicted. The embodiment of FIG. 4 is based on the embodiment of FIG. 1 and additionally depicts that the device 10 is configured to communicate signaling data S and billing data B with the core mobile network 31 directly. Without loss of generality, FIG. 4 depicts that the signaling data S and the billing data B are exchanged between the gateway 41 and the first user entity 21 over the device 10.

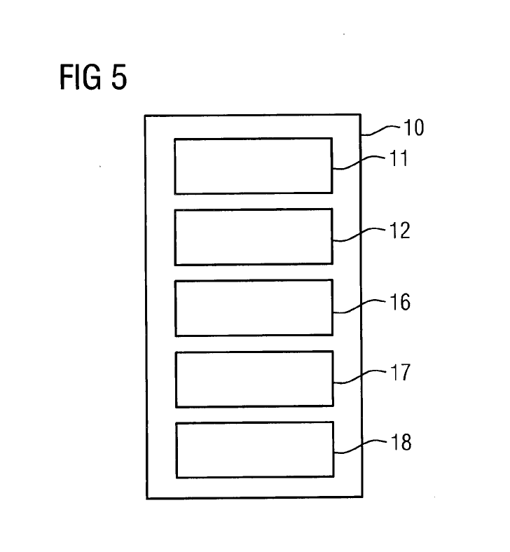

FIG. 5 depicts a schematic block diagram of an embodiment of the device 10 for coupling a plurality of user entities 21, 22 in a communication network 31, 32. The device 10 of FIG. 5 has the first unit 11, the second unit 12, a virtualization unit 16, an allocation unit 17, and a server 18. The virtualization unit 16 is configured to provide virtualized network functions to the user entities 21, 22. For example, the virtualization unit 16 may provide a number of firewalls, where each of the provided firewalls is configured to couple at least two of the provided virtual networks VN1-VN3.

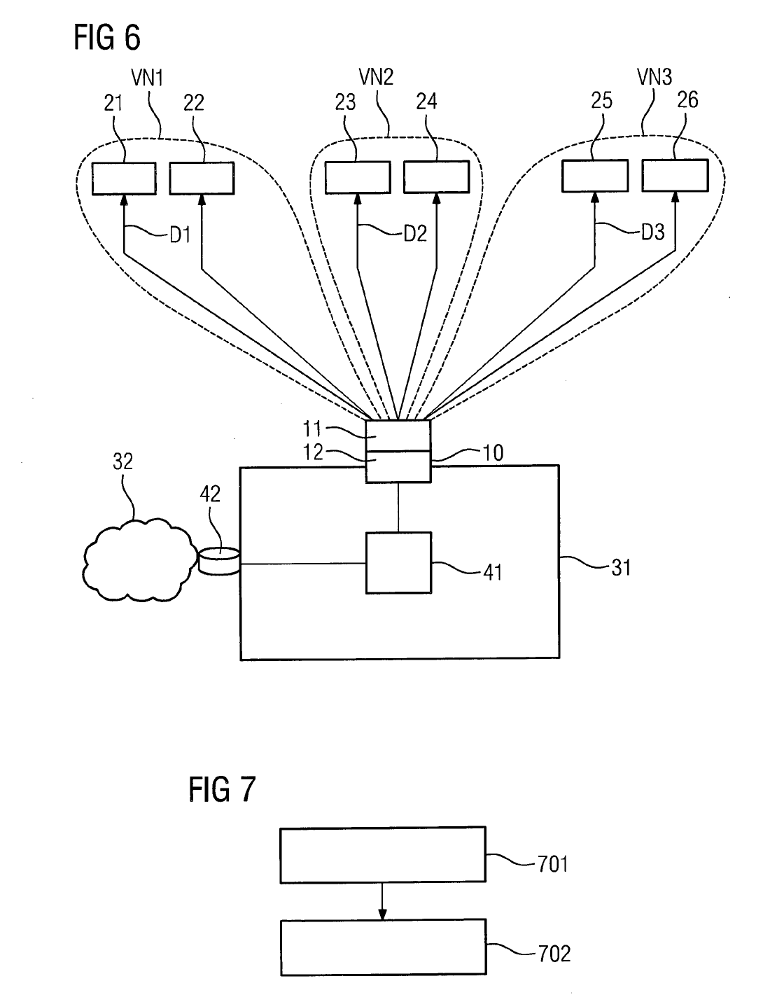

FIG. 6 depicts an embodiment of a device 10 providing three different virtual networks VN1-VN3, where two user entities (e.g., elements 21, 22; 23, 24; and 25, 26) are allocated to one of the respective virtual networks VN1-VN3, respectively.

The allocation unit 17 of FIG. 5 is configured to allocate a certain user entity 21-26 to one certain virtual network VN1-VN3 of the provided virtual networks VN1-VN3. In the example of FIG. 6, the allocation unit 17 allocated the user entities 21, 22 to the virtual network VN1, the user entities 23, 24 to the virtual network VN2, and the user entities 25, 26 to the virtual network VN3. The allocation unit 17 may proceed the allocation based on information for each user entity 21-26 that is indicative for a certain group of which the certain user entity 21-26 is part. The server 18 of FIG. 5 may be configured to provide services to the plurality of user entities 21-26. For example, the server 18 is a virtual server on the device 10.

FIG. 7 depicts an embodiment of a sequence of method steps for coupling a plurality of user entities 21, 22 in a communication network 31, 32. For example, such a communication network 31, 32 is shown in FIG. 1.

In act 701, communication links between each of the user entities 21, 22 and the core mobile network 31 of the communication network 31, 32 are provided.

In act 702, a number of virtual networks (e.g., elements VN; VN1-VN3) are provided, where each of the provided virtual networks (e.g., VN; VN1-VN3) is configured to connect at least two of the user entities 21-26 such that the direct communication D between the connected at least two user entities 21-26 is provided.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A device for coupling a plurality of user entities in a communication network, the device comprising:
a first unit configured to provide communication links between each user entity of the plurality of user entities and a core mobile network of the communication network; and
a second unit configured to provide virtual networks;
wherein each of the provided virtual networks is configured to connect at least two user entities of the plurality of user entities such that a direct communication between the connected at least two user entities is provided.

2. The device of claim 1, wherein the core mobile network is a cellular network.

3. The device of claim 1, further comprising:
a base station, wherein the base station integrates the first unit.

4. The device of claim 3, wherein the base station is a NodeB or an eNodeB.

5. The device of claim 1, further comprising:
a local gateway, wherein the local gateway integrates the second unit.

6. The device of claim 1, further comprising:
a processing unit having processing power and storing capacity, wherein the processing unit integrates the second unit.

7. The device of claim 1 wherein the direct communication between the at least two user entities connected by one of the provided virtual networks is a direct data communication.

8. The device of claim 7, wherein the device is configured to communicate signaling data and billing data with the core mobile network directly.

9. The device of claim 1, further comprising:
a virtualization unit configured to provide virtualized network functions to the plurality of user entities.

10. The device of claim 9, wherein the virtualization unit is configured to provide a plurality of firewalls, wherein each firewall of the plurality of provided firewalls is configured to couple at least two of the provided virtual networks.

11. The device of claim 1, further comprising:
an allocation unit configured to allocate a certain user entity of the plurality of user entities to one certain virtual network of the provided virtual networks.

12. The device of claim 1 further comprising:
an allocation unit configured to allocate a certain user entity of the plurality of user entities to one certain virtual network of the provided virtual networks based on information being indicative for a certain group the certain user entity is a part of.

13. The device of claim 1, further comprising:
a server configured to provide services to the plurality of user entities, wherein the server is a virtual server.

14. A method for coupling a plurality of user entities in a communication network, the method comprising:
providing communication links between each user entity of the plurality of user entities and a core mobile network of the communication network; and
providing a plurality of virtual networks, wherein each virtual network of the plurality of provided virtual networks is configured to connect at least two user entities of the plurality of user entities such that a direct communication between the connected at least two user entities is provided.

15. A non-transitory computer-readable storage medium having stored thereon a computer program executable by one or more processors for coupling a plurality of user entities in a communication network, the computer program comprising instructions, the instructions comprising:
providing communication links between each user entity of the plurality of user entities and a core mobile network of the communication network; and
providing a plurality of virtual networks, wherein each virtual network of the plurality of provided virtual networks is configured to connect at least two user entities of the plurality of user entities such that a direct communication between the connected at least two user entities is provided.

16. The device of claim 2, further comprising:
a base station, wherein the base station integrates the first unit.

17. The device of claim 16, wherein the base station is a NodeB or an eNodeB.

18. The device of claim 17, further comprising:
a local gateway, wherein the local gateway integrates the second unit.

19. The device of claim 18, further comprising:
a processing unit having processing power and storing capacity, wherein the processing unit integrates the second unit.

20. The device of claim 19, wherein the direct communication between the at least two user entities connected by one of the provided virtual networks is a direct data communication.
